(19) United States
(12) Patent Application Publication
(10) Pub. No.: US 2005/0078138 A1
(43) Pub. Date: Apr. 14, 2005

(54) Method for visually recognizing a droplet, droplet discharge head inspection device, and droplet discharge device

(75) Inventor: Minoru Koyama, Matsumoto-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/927,063

(22) Filed: Aug. 27, 2004

(30) Foreign Application Priority Data
Aug. 27, 2003 (JP) 2003-303571

(51) Int. Cl. B41J 29/393

(52) U.S. Cl. 347/19

(57) ABSTRACT

Aspects of the invention can provide a method for visually recognizing a droplet, a droplet discharge head inspection device, and a droplet discharge device that are capable of easily visually recognizing an airborne droplet discharged from a nozzle hole of a droplet discharge head. The droplet discharge head inspection device can provide visual recognition of an airborne droplet discharged from a nozzle hole included in a droplet discharge head, and includes a laser light irradiation device that irradiates laser light and a plate member having a slit through which the laser light passes. The laser light is made pass through the slit so as to be shaped into flat-shaped light beams, that is, laser light. With the laser light laid out in parallel with a course of the droplet, the course is irradiated with the laser light. This makes it possible to illuminate and easily visually recognize the airborne droplet.

### BACKGROUND OF THE INVENTION

1. Field of Invention

Aspects of the invention can relate to a method for visually recognizing a droplet, a droplet discharge head inspection device, and a droplet discharge device that are capable of visually recognizing an airborne droplet discharged from a nozzle hole of a droplet discharge head.

2. Description of Related Art

A related droplet discharge device for discharging droplets on a substrate by using a droplet discharge head having the same mechanism as the inkjet head of ink-jet printers is described, for example, in Japanese Unexamined Patent Publication No. 10-260307. The device is used for industrial purposes, for example, manufacturing a color filter for a liquid crystal display and an organic electroluminescent (EL) display and forming a metal wiring on a substrate. This droplet discharge device and a device for inspecting the performance of the droplet discharge head are expected to allow an operator to visually recognize droplets discharged from the droplet discharge head, so that how well droplets have been discharged can be easily checked. In the related devices, however, it can be difficult to visually recognize discharged droplets since the diameter of such droplets is too small. It is particularly difficult to visually recognize droplets discharged from a droplet discharge head with its nozzle looking downward, since the droplets are not disposed to lighting.

### SUMMARY OF THE INVENTION

Aspects of the invention can provide a method for visually recognizing a droplet, a droplet discharge head inspection device, and a droplet discharge device that are capable of easily visually recognizing an airborne droplet discharged from a nozzle hole of a droplet discharge head.

The method for visually recognizing a droplet according to one aspect of the invention can provide visual recognition of an airborne droplet discharged from a nozzle hole included in a droplet discharge head. The method for visually recognizing a droplet can include the following making laser light pass through a slit so as to shape the laser light into a flat-shaped light beam, and irradiating a course of the droplet with the flat-shaped light beam laid out in parallel with the course, so as to illuminate and visually recognize the airborne droplet. The method for visually recognizing a droplet makes it easy to visually recognize an airborne droplet discharged from the nozzle hole included in the droplet discharge head.

According to the invention, the method for visually recognizing a droplet preferably can include making the laser light pass through a condenser lens before or after passing through the slit. This makes it easy to adjust the width of the light beam of the laser light that intersects the course of the droplet, that is, the length of the course that is irradiated with the laser light.

According to the invention, the method for visually recognizing a droplet preferably use the slit that is formed at an interval along its longitudinal direction. This reduces brightness in visually recognizing the droplet even if the output from the laser light is large, making it easy to see the airborne droplet.

A droplet discharge head inspection device according to another aspect of the invention can provide visual recognition of an airborne droplet discharged from a nozzle hole included in a droplet discharge head. The droplet discharge head inspection device includes a laser light irradiation device for irradiating laser light, and a plate member including a portion defining a slit through which the laser light passes. With this structure, the laser light is made pass through the slit so as to be shaped into a flat-shaped light beam. Furthermore, a course of the droplet is irradiated with the flat-shaped light beam laid out in parallel with the course, so as to illuminate and visually recognize the airborne droplet. The droplet discharge head inspection device makes it easy to visually recognize an airborne droplet discharged from the nozzle hole included in the droplet discharge head.

According to the invention, the droplet discharge head inspection device preferably can include a light receiving device for receiving the laser light and converts the laser light into electricity, and an inspection device for inspecting how well a droplet is discharged from the nozzle hole based on an output signal from the light receiving device. This makes it possible to not only visually recognize but also automatically inspect how well the droplet is discharged from the nozzle hole.

According to the invention, the droplet discharge head inspection device preferably can include a nozzle hole selection device for selecting a nozzle hole out of a plurality of nozzle holes included in the droplet discharge head, so that a droplet discharged from the selected nozzle hole is visually recognized, by relatively scanning the laser light to each course of the plurality of nozzle holes. This way the course of the droplet discharged from one nozzle hole out of the plurality of nozzle holes of the droplet discharge head is irradiated with the laser light. Thus the airborne droplet discharged from this specified nozzle hole is visually recognized.

According to the invention, the droplet discharge head inspection device preferably can include a nozzle hole specifying device for receiving specification of a nozzle hole, so that a droplet discharged from the specified nozzle hole is visually recognized. With this structure, the nozzle hole selection device irradiates a course of a drop discharged from the nozzle hole specified by the nozzle hole specifying device with the laser light. This allows an operator to freely specify one nozzle hole out of the plurality of nozzle holes included in the droplet discharge head, so that a droplet discharged from the specified nozzle hole can be visually recognized.

A droplet discharge device according to another aspect of the invention can include a work table for retaining a work, a droplet discharge head for discharging a droplet to the work so as to provide visual recognition of an airborne droplet discharged from a nozzle hole included in the droplet discharge head, a laser light irradiation device for irradiating laser light, and a plate member including a portion defining a slit through which the laser light passes. With this structure, the laser light is made pass through the slit so as to be shaped into a flat-shaped light beam. Furthermore, a course of the droplet is irradiated with the flat-shaped light beam laid out in parallel with the course, so as to illuminate and visually recognize the airborne droplet. The droplet discharge device makes it easy to visually recognize an airborne droplet discharged from the nozzle hole included in the droplet discharge head.

According to the invention, the droplet discharge device preferably includes a light receiving device for receiving the laser light and converts the laser light into electricity, and an inspection device for inspecting how well a droplet is discharged from the nozzle hole based on an output signal from the light receiving device. This makes it possible to not only visually recognize but also automatically inspect how well the droplet is discharged from the nozzle hole. Inspection results may be reported to the operator with a reporting device, such as a display. Based on the inspection results, a head recovery device for recovering the function of the droplet discharge head may be operated.

### BRIEF DESCRIPTION OF THE DRAWINGS

The invention will be described with reference to the accompanying drawings, wherein like numerals reference like elements, and wherein:

FIG. 1 is a side view showing a droplet discharge head inspection device according to one embodiment of the invention;

FIG. 2 is a plan view showing the droplet discharge head inspection device according to the embodiment of the invention;

FIG. 3 is a front view of a light shielding plate included in the droplet discharge head inspection device shown in FIGS. 1 and 2;

FIG. 3 is a front view of a light shielding plate included in the droplet discharge head inspection device shown in FIGS. 1 and 2;

FIG. 5 is a functional block diagram of the droplet discharge head inspection device shown in FIGS. 1 and 2;

FIG. 6 is a side view showing a droplet discharge device according to one embodiment of the invention; and

FIG. 7 is a functional block diagram of the droplet discharge device shown in FIG. 6.

### DETAILED DESCRIPTION OF PREFERRED EMBODIMENTS

A method for visually recognizing a droplet, a droplet discharge head inspection device, and a droplet discharge device according to exemplary embodiments of the invention will now be described with reference to the accompanying drawings.

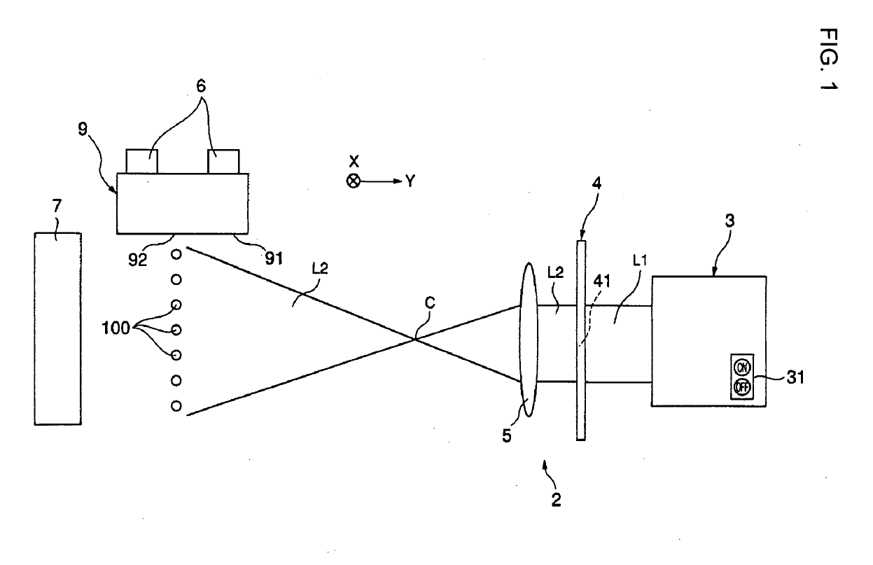

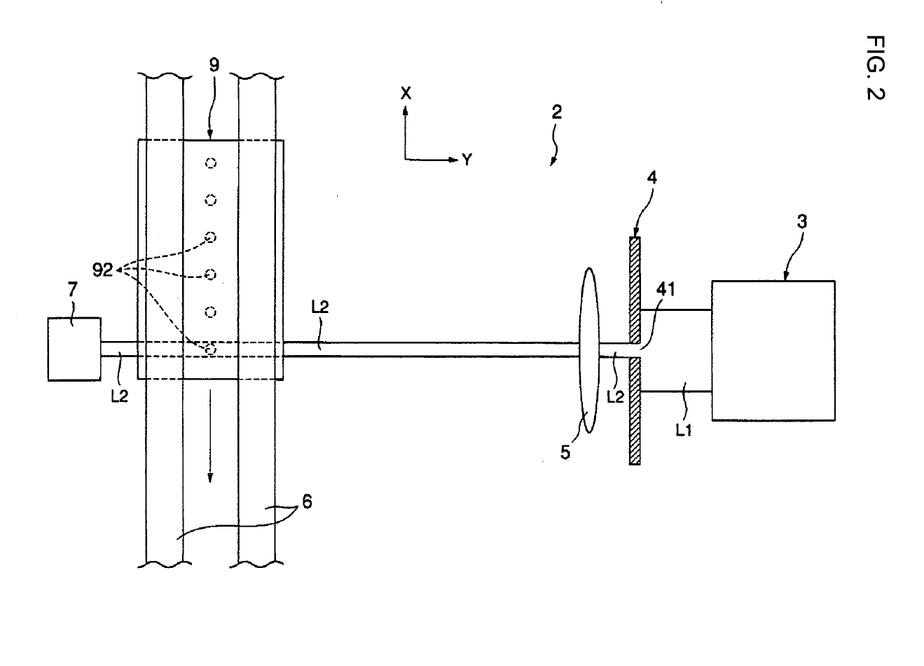

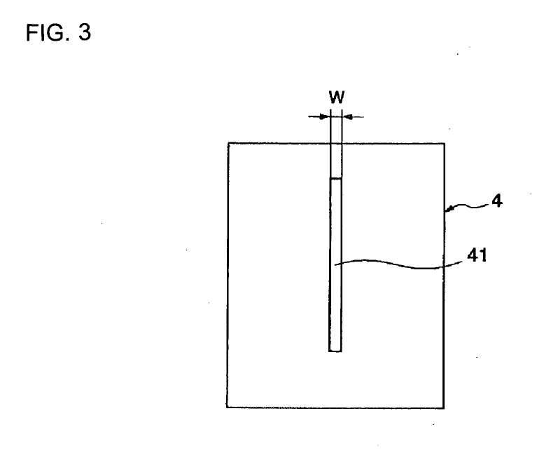

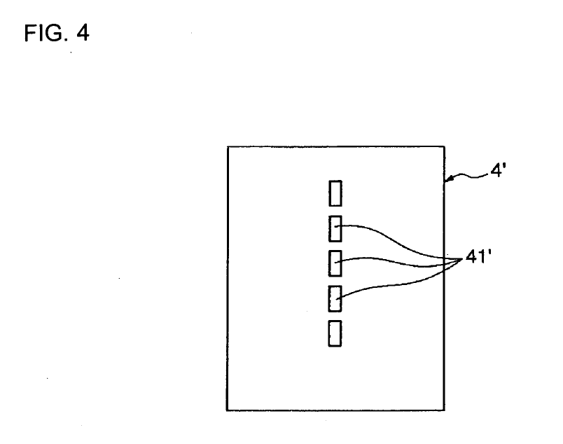

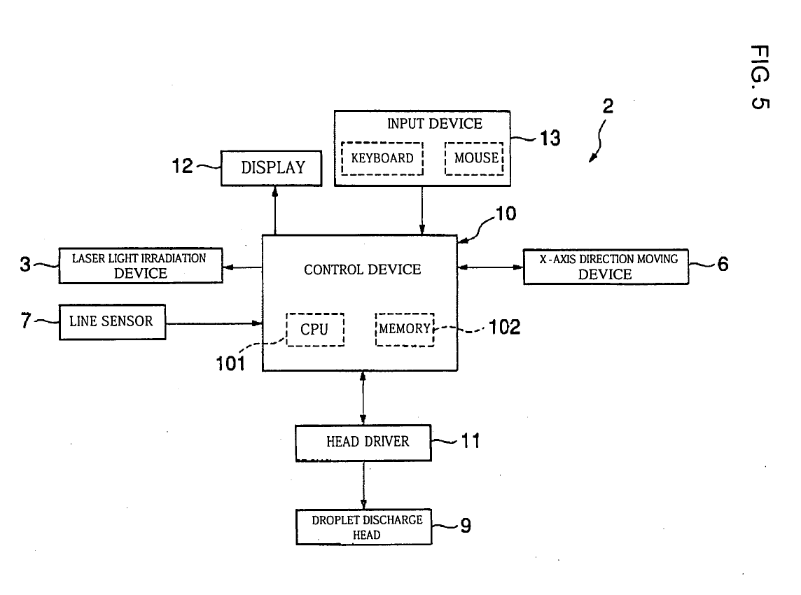

FIGS. 1 and 2 are a side and plan view, respectively, of the droplet discharge head inspection device of one exemplary embodiment of the invention. FIGS. 3 and 4 are front views of a light shielding plate included in the droplet discharge head inspection device shown in FIGS. 1 and 2, respectively. FIG. 5 is a functional block diagram of the droplet discharge head inspection device shown in FIGS. 1 and 2.

For convenience, the upper and lower side of FIG. 1 and the vertical and horizontal direction of FIG. 2 are referred to as the upper and lower side and the x- and y-axis direction, respectively, in the description below. A droplet discharge head inspection device 2 shown in the drawings is a device for inspecting the operation of a droplet discharge head 9. The droplet discharge head 9 will now be described in greater detail.

As shown in FIGS. 1 and 2, the droplet discharge head 9 (inkjet head) has a nozzle surface 91 on its lower side. On the nozzle surface 91, a nozzle hole 92 is provided in the plural number in a line or more lines (in a line in the drawings) along the x-axis direction. Each nozzle hole 92 is provided with a pressure cell or cavity (not shown) that communicates with the nozzle hole 92 and an actuator (not shown) that changes the pressure of a liquid filled in the pressure cell.

The droplet discharge head 9 is driven by a head driver 11. The head driver 11 sends a drive signal to the actuator of the droplet discharge head 9 based on the control by a control device 10.

Upon receiving the driving signal, the actuator starts operating and changes the voltage of a liquid in the pressure cell. As a result, the liquid in the pressure cell is discharged from the nozzle hole 92 downward as a droplet 100. Examples of the actuator of the droplet discharge head 9 may include, but not be limited to, a piezo actuator and an electrostatic actuator. Alternatively, the droplet discharge head 9 is a film boiling inkjet head having a heater as the actuator for heating a liquid to generate air bubbles.

Examples of the liquid (including a dispersion liquid) discharged from the droplet discharge head 9 may include, but not be limited to, any liquids such as inks, color filter materials, fluorescent materials for forming an EL light emitting layer included in an organic EL device, fluorescent materials for forming phosphors used for a PDP device, electrophoresis materials for forming electrophoresis elements used for an electrophoresis display, bank materials for forming a bank on the surface of a substrate, coating materials, liquid electrode materials for forming an electrode, particle materials for forming a spacer that is part of a micro cell gap between two substrates, liquid metal materials for forming a metal wiring, lens materials for forming a micro lens, resist materials, and light diffusion materials for forming light diffusion elements.

The droplet discharge head inspection device 2 will now be described in greater detail. The droplet discharge head inspection device 2 includes a laser light irradiation device 3 that shines laser light L₁ and a plate member 4 having a slit 41 through which the laser light L₁ passes.

Examples of the laser light irradiation device 3 may include, but not be limited to, air lasers such as Ne-He, Ar, and CO₂ lasers, solid lasers such as ruby, YAG, and glass lasers, and semiconductor lasers.

As shown in FIG. 3, the plate member 4 is flat. The slit 41 that is straight is formed in the plate member 4. The width W of the slit 41 is not limited, but is preferably from one to five times as large as the diameter D of the droplet 100, and more preferably from one to two times as large as the diameter D.

On the surface of the plate member 4 on which the laser light L₁ is shone, diffusion treatment for diffusing light is preferably applied. This prevents reflected light that are partial light beams of the laser light L₁ that have not passed through the slit 41 from going into a certain direction, so that operator safety can be ensured.

It should be understood that the cross section of light beams of the laser light L₁ irradiated by the laser light irradiation device 3 is not limited, but is circular in general. Accordingly, the light beams of the laser light L₁ are column-shaped.

As passing through the slit 41, the laser light L₁ is shaped into flat-shaped light beams, that is, laser light L₂ as shown in FIG. 2. With the flat-shaped light beams laid out in parallel with the course of the droplet 100, the laser light L₂ illuminates the course from the side of the course, i.e. in the y-axis direction. Thus, the airborne droplet 100 illuminated by the laser light L₂ becomes visible. This allows an operator to easily recognize the airborne droplet 100.

This way the droplet discharge head inspection device 2 makes it easy to visually recognize how well the droplet 100 is discharged from the nozzle hole 92. This also makes it possible to easily finds out that the droplet 100 is not discharged straight and insufficiently discharged due to clogging of the nozzle hole 92. The direction in which the droplet 100 is visually recognized is not limited. For example, the droplet 100 can be visually recognized in the direction perpendicular or at an angle to the direction in which the laser light L₂ is shone.

The droplet discharge head inspection device 2 of the exemplary embodiment can include a condenser lens 5. The laser light L₂ that has passed through the slit 41 of the plate member 4 and been flat-shaped further passes through this condenser lens 5. After passing through the condenser lens 5, the laser light L₂ is concentrated on a focal point C. After passing the focal point C, the light gradually increases its width (in the vertical direction in FIG. 1) in the form of light beams as it makes its way in the direction of movement. These light beams illuminate the course of the droplet 100. Even if the width of the light beams of the laser light L₂ before passing through the condenser lens 5 is small, this structure can make the width of the light beams of the laser light L₂ intersecting the course of the droplet 100, that is, the length of the course that is irradiated with the laser light L₂, large by placing the droplet discharge head 9 far from the focal point C.

Here, the condenser lens 5 may be placed before the slit 41. If the width of the light beams of the laser light L₂ is sufficiently large without passing through the condenser lens 5, the condenser lens 5 can be omitted.

In another exemplary embodiment of the invention, it is possible to curve the path of the laser light L₁ or the laser light L₂ by adding a mirror in the path to the structure shown in the drawings. This increases the flexibility of where to place the laser light irradiation device 3 in this structure.

Upon seeing the airborne droplet 100 irradiated with the laser light L₂, it is likely that light reflected on the droplet 100 is too bright when the output from the laser light irradiation device 3 is too large.

In this case, a plate member 4′ shown in FIG. 4 tones down the brightness. Referring to FIG. 4, a slit 41′ is formed in the plate member 4′ straight along its longitudinal direction (The slit is divided into two or more pieces.). This lowers the rate of light reflected on the droplet 100, tones down the brightness, and makes it easy to see the droplet 100.

As shown in FIG. 1, the laser light irradiation device 3 can include a switch 31 for turning on and off of the oscillation of the laser light L₁. This allows the laser light irradiation device 3 to make the laser light L₁ oscillate only in visually recognizing the airborne droplet 100 and to stop operating at any time except that, which can reduce power consumption. Here, a push button may replace the switch 31 in this structure. In this case, while the push button is being pressed, the laser light irradiation device 3 makes the laser light L₁ oscillate.

The droplet discharge head inspection device 2 of the exemplary embodiment also includes an x-axis direction moving device 6 and a line sensor 7 (light receiving device). The x-axis direction moving device 6 makes the droplet discharge head 9 move in the x-axis direction. The line sensor 7 receives the laser light L₂ and converts the light into electricity. The droplet discharge head inspection device 2 also includes a control device 10, a display 12, and an input device 13 as shown in FIG. 5.

It should be understood that the configuration of the x-axis direction moving device 6 may include, but not be limited to, a configuration employing a linear motor system and a configuration using a ball screw and a servomotor for providing rotary driving of the screw.

The display 12 may be a cathode-ray tube (CRT) or a liquid crystal display, and provide an operation and data input display, for example. The input device 13 may be a keyboard and a mouse, for example.

Operating the x-axis direction moving device 6 so as to make the droplet discharge head 9 move in the x-axis direction as shown in FIG. 2 makes the laser light L₂ scan each course corresponding to the nozzle hole 92 that is provided in the plural number. This way the course of the droplet 100 discharged from one nozzle hole 92 of the droplet discharge head 9 is irradiated with the laser light L₂. Thus, the airborne droplet 100 discharged from this specified nozzle hole 92 is visually recognized.

According to the exemplary embodiment as described above, the x-axis direction moving device 6 functions as a nozzle hole selection device that selects one nozzle hole 92, so that the airborne droplet 100 discharged from this specified nozzle hole 92 is visually recognized. Instead of the x-axis direction moving device 6, a structure for moving the laser light irradiation device 3 and the plate member 4 so as to make the laser light L₂ scan, or a structure using a galvanometer or polygon mirror so as to make the laser light L₂ scan may also be used as the nozzle hole selection device.

An operator inputs the number of one nozzle hole 92 to the control device 10 with the input device 13, so that the droplet 100 discharged from this specified nozzle hole 92 is visually recognized. In other words, the input device 13 functions as a nozzle hole specifying device that receives specification of one nozzle hole 92, so that the droplet 100 discharged from this specified nozzle hole 92 is visually recognized. The control device 10 operates the x-axis direction moving device 6 based on the data input by the input device 13, and moves the droplet discharge head 9 so that the course of the droplet 100 of the specified nozzle hole 92 is irradiated with the laser light L₂. Thus, the operator visually recognizes the airborne droplet 100 discharged from the specified nozzle hole 92.

According to the exemplary embodiment, the line sensor 7 included in the droplet discharge head inspection device 2 may be used for automatically inspecting how well the droplet 100 is discharged from the nozzle hole 92. In this case, the control device 10 functions as an inspection device that inspects how well the droplet 100 is discharged from the nozzle hole 92 based on an output signal from the line sensor 7.

The control device 10 finds out that the droplet 100 is not discharged straight and insufficiently discharged from the nozzle hole 92 as described below, for example. First, when the line sensor 7 detects that the droplet 100 has crossed the laser light L₂ in a way that the droplet 100 has cut across the light beams of the laser light L₂ from top to down in FIG. 1, the control device 10 determines that the droplet 100 is discharged normally. When the line sensor 7 detects that the droplet 100 has crossed only the upper part of the light beams of the laser light L₂, the control device 10 determines that the droplet 100 is not discharged straight (displacement in the discharge direction). When no change has been made in the output signal from the line sensor 7 while the droplet discharge head 9 discharges a droplet, the control device 10 determines that the droplet 100 is insufficiently discharged due to clogging of the nozzle hole 92.

According to the exemplary embodiment, it is possible to not only visually recognize, but also automatically inspect how well the droplet 100 is discharged from the nozzle hole 92 as mentioned above. The automatic inspection also makes it possible to select one nozzle hole 92, so that the droplet discharged from this specified nozzle hole 92 is inspected by scanning the laser light L₂ in the same manner as mentioned above.

It should be understood that the light receiving device that receives the laser light L₂ and converts the light into electricity is not limited to the line sensor 7. For example, imaging devices such as a photodiode and a charge coupled device (CCD) may be also used instead.

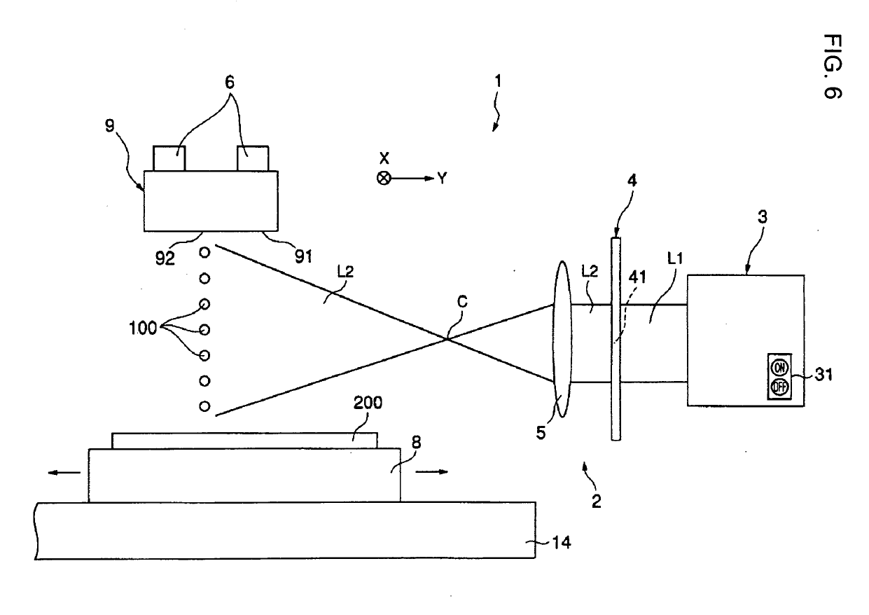

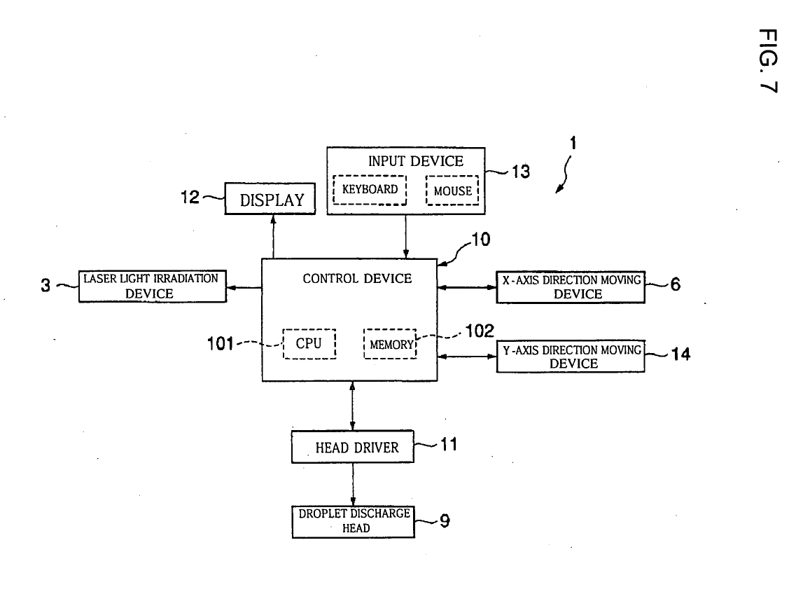

FIG. 6 is a side view showing a droplet discharge device according to one exemplary embodiment of the invention. FIG. 7 is a functional block diagram of the droplet discharge device shown in FIG. 6.

Referring to the drawings, the droplet discharge device of the exemplary embodiment of the invention will now be described, mainly about differences from the above-mentioned structures. The description of the structures they have in common will be omitted.

A droplet discharge device 1 shown in the drawings can include the droplet discharge head inspection device 2 that is the same as the above-mentioned structures except for the fact that the line sensor 7 is not included here. The droplet discharge device 1 also makes it easy to visually recognize the airborne droplet 100 ejected from the nozzle hole 92 included in the droplet discharge head 9 in the same manner as mentioned above.

The droplet discharge device 1 can include the droplet discharge head inspection device 2, the droplet discharge head 9 that ejects the droplet 100 to a work 200, a work table 8 that retains the work 200, and a y-axis direction moving device 14 that makes the work table 8 move in the y-axis direction. Examples of the work 200 may include, but not be limited to, various types of substrates such as glass, silicon, and flexible substrates, and optical members such as lenses.

The work table 8 is provided with a retaining device (not shown) for retaining the work 200 that is mounted by vacuum suction, for example.

The configuration of the y-axis direction moving device 14 may include, but not be limited to, a configuration employing a linear motor system and a configuration using a ball screw and a servomotor for providing rotary driving of the screw.

The droplet discharge device 1 operates the x-axis direction moving device 6 and the y-axis direction moving device 14 based on the control by the control device 10, makes the droplet discharge head 9 and the work 200 relatively move by setting the x- and y-axis direction as either a main or secondary scanning direction, and ejects the droplet 100 from the nozzle hole 92 to the work 200. Thus, a given image pattern is drawn on the work 200.

The droplet discharge device 1 also makes it easy to visually recognize the droplet 100 ejected from the nozzle hole 92 in the same manner as mentioned above. Thus, the droplet discharge device 1 makes it possible to quickly detect failures if any, for example, the droplet 100 is not discharged straight and insufficiently discharged, and thereby improving the quality and yield of products.

The droplet discharge device 1 may be also provided with a light receiving device, for example, the line sensor 7, so that the control device 10 can automatically inspect how well the droplet 100 is discharged from the nozzle hole 92 based on an output signal from this light receiving device. This makes it possible to automatically finds out that the droplet 100 is not discharged straight or insufficiently discharged due to clogging of the nozzle hole 92. When the droplet 100 is found to be not discharged straight or insufficiently discharged with the droplet discharge head 9, it is preferable that the control device 10 displays these failures on a display (not shown) and lets an operator know the occurrence of the failures. When the droplet 100 is found to be not discharged straight or insufficiently discharged, the control device 10 may operate a head recovery device (not shown) so as to recover the function of the droplet discharge head 9 and eliminate the clogging of the nozzle hole 92 and discharge failure. Examples of the head recovery device include a wiping mechanism that wipes and cleans the nozzle surface 91 of the droplet discharge head 9, and a capping extraction mechanism that attaches a cap closely to the nozzle surface 91 and extracts liquid from the nozzle hole 92 to eliminate clogging.

While the method for visually recognizing a droplet, the droplet discharge head inspection device, and the droplet discharge device of the invention have been described in terms of exemplary embodiments with reference to the accompanying drawings, they are not intended to limit the invention. Each element of the droplet discharge head inspection device and the droplet discharge device may be replaced with any equivalents. In other instances, given elements can be added to the structures described above.

1. A method for visually recognizing a droplet that provides visual recognition of an airborne droplet discharged from a nozzle hole included in a droplet discharge head, comprising:
passing laser light through a slit so as to shape the laser light into a flat-shaped light beam; and
irradiating a course of the droplet with the flat-shaped light beam laid out in parallel with the course, so as to illuminate and visually recognize the airborne droplet.

2. The method for visually recognizing a droplet according to claim 1, further comprising:
passing the laser light through a condenser lens before or after passing through the slit.

3. The method for visually recognizing a droplet according to claim 1, the slit being formed at an interval along a longitudinal direction.

4. A droplet discharge head inspection device that provides visual recognition of an airborne droplet discharged from a nozzle hole included in a droplet discharge head, comprising:
a laser light irradiation device that irradiates laser light; and
a plate member including a portion defining a slit through which the laser light passes;
the laser light passing through the slit so as to be shaped into a flat-shaped light beam, and a course of the droplet being irradiated with the flat-shaped light beam laid out in parallel with the course, so as to illuminate and visually recognize the airborne droplet.

5. The droplet discharge head inspection device according to claim 4, further comprising:
a light receiving device that receives the laser light and converts the laser light into electricity; and
an inspection device that inspects how well a droplet is discharged from the nozzle hole based on an output signal from the light receiving device.

6. The droplet discharge head inspection device according to claim 4, further comprising:
a nozzle hole selection device that selects a nozzle hole out of a plurality of nozzle holes included in the droplet discharge head, so that a droplet discharged from the selected nozzle hole is visually recognized, by relatively scanning the laser light to each course of the plurality of nozzle holes.

7. The droplet discharge head inspection device according to claim 6, further comprising:
a nozzle hole specifying device that receives specification of a nozzle hole, so that a droplet discharged from the specified nozzle hole is visually recognized;
the nozzle hole selection device irradiating a course of a drop discharged from the nozzle hole specified by the nozzle hole specifying device with the laser light.

8. A droplet discharge device, comprising:
a work table that retains a work;
a droplet discharge head that discharges a droplet to the work so as to provide visual recognition of an airborne droplet discharged from a nozzle hole included in the droplet discharge head;
a laser light irradiation device that irradiates laser light; and
a plate member including a portion defining a slit through which the laser light passes;
the laser light passing through the slit so as to be shaped into a flat-shaped light beam, and a course of the droplet being irradiated with the flat-shaped light beam laid out in parallel with the course, so as to illuminate and visually recognize the airborne droplet.

9. The droplet discharge device according to claim 8, further comprising:
a light receiving device that receives the laser light and converts the laser light into electricity; and
an inspection device that inspects how well a droplet is discharged from the nozzle hole based on an output signal from the light receiving device.
